(19) United States
(12) Patent Application Publication
(10) Pub. No.: US 2025/0388077 A1
(43) Pub. Date: Dec. 25, 2025

(54) VEHICLE BODY STRUCTURE

(71) Applicants: Hyundai Motor Company, Seoul (KR); Kia Corporation, Seoul (KR)

(72) Inventor: ChangHak Kang, Hwaseong-si (KR)

(21) Appl. No.: 18/961,035

(22) Filed: Nov. 26, 2024

(30) Foreign Application Priority Data
Jun. 19, 2024 (KR) 10-2024-0079651

(51) Int. Cl. B60K 15/07; B60L 50/71

(52) U.S. Cl. CPC B60K 15/07; B60L 50/71; B60L 2200/36

(57) ABSTRACT

A vehicle body structure can include a front body assembly, a center floor assembly, and a rear floor assembly connected to each other along the front-rear direction of the vehicle body. The vehicle body structure can include a side sill that is arranged along the front-rear direction of the vehicle body on both sides of the vehicle width direction of the center floor assembly and connected to the front body assembly, a hydrogen tank mounting structure positioned at the front of the center floor assembly to mount at least one hydrogen tank to the lower portion of the center floor assembly, and a fuel cell stack mounting structure positioned at the rear portion of the center floor assembly so as to mount at least one fuel cell stack to the lower portion of the center floor assembly.

### CROSS-REFERENCE TO RELATED APPLICATIONS

This application claims priority to and the benefit of Korean Patent Application No. 10-2024-0079651, filed on Jun. 19, 2024, which application is hereby incorporated herein by reference in its entirety.

### TECHNICAL FIELD

The present disclosure relates to a vehicle body structure.

### BACKGROUND

In general, the development and demand for environmentally-friendly vehicles are increasing as the discharge reference of oxidation carbon is strengthened.

Examples of environmentally-friendly vehicles include hybrid vehicles, electric vehicles, hybrid electric vehicles, and hydrogen electric vehicles (a person of an ordinary skill in the art is also commonly referred to as a ‘hydrogen power vehicle’).

Among these, various parts such as a high voltage battery, fuel cell stack, drive motor, hydrogen tank, and cooling module are mounted on the vehicle body of a hydrogen electric vehicle.

Recently, hydrogen electric vehicle-based commercial vehicles and even LCVs (Light Commercial Vehicles) are being introduced.

LCV here refers to a type of commercial vehicle used in Europe, Australia, Canada, etc., and in principle refers to a medium-sized commercial vehicle with a gross weight of less than 3.5 tons.

However, such hydrogen electric vehicle-based LCVs have difficulties mounting large-capacity hydrogen tanks and high-power fuel cell stacks in the limited space of the vehicle body. Additionally, hydrogen electric vehicle-based LCVs may cause damage to various parts in the event of a vehicle collision.

The information contained in this Background section has been prepared to provide understanding of the background of the present disclosure and may include matters that are not prior art already publicly known, available, or in use.

### SUMMARY

An embodiment of the present disclosure can provide a vehicle body structure that can secure a space for mounting a hydrogen tank and a fuel cell stack, and secure the mount strength and collision performance of the hydrogen tank and fuel cell stack.

A vehicle body structure can include a front body assembly, a center floor assembly, and a rear floor assembly connected to each other along the front-rear direction of the vehicle body. A vehicle body structure according to an embodiment of the present disclosure may include a side sill that is arranged along the front-rear direction of the vehicle body on both sides of the vehicle width direction of the center floor assembly and connected to the front body assembly, a hydrogen tank mounting unit positioned at the front of the center floor assembly to mount at least one hydrogen tank to the lower portion of the center floor assembly, and a fuel cell stack mounting unit positioned at the rear portion of the center floor assembly so as to mount at least one fuel cell stack to the lower portion of the center floor assembly.

A vehicle body structure according to an embodiment of the present disclosure may further include a mount tray assembly engaged with the side sill to mount the at least one hydrogen tank and the at least one fuel cell stack to the hydrogen tank mounting unit and the fuel cell stack mounting unit.

A hydrogen tank mounting unit may include a seat mounting member connected to a front side member of the front body assembly and connected to the side sill.

A fuel cell stack mounting unit may include a center floor panel connected to the rear of the seat mounting member, and a center cross member and a rear cross member connected along the vehicle width direction to the side sill and connected at a predetermined interval to the lower surface of the center floor panel.

A seat mounting member may be positioned between the front cross member and the center cross member, which can be positioned along the vehicle width direction in the front body assembly.

A seat mounting member may include a front flange portion connected to a dash panel and the front side member of the front body assembly, a rear flange portion connected to the front portion of the center floor panel, and a seat mounting portion formed between the front flange portion and the rear flange portion.

A hydrogen tank mount space may be formed at the bottom of the seat mounting member.

A fuel cell stack mount space may be formed between the lower surface of the center floor panel, the center cross member, and the rear cross member.

A mount tray assembly may include a tank mounting frame engaging the side sill at a position corresponding to the hydrogen tank mounting unit for mounting at least one hydrogen tank, and a stack mounting frame connected to the tank mounting frame to mount at least one fuel cell stack and engaged with the side sill at a position corresponding to the fuel cell stack mounting unit.

A tank mounting frame may include a plurality of tank mount members connected in a lattice form.

Each of the tank mount members may include a lower rail member and an upper rail member connected by welding along the vertical direction to form a closed space.

The tank mount members may be arranged in a ‘#’ shape and connected by welding.

A tank mounting frame may be equipped with at least one strap band clamper that is configured to clamp at least one hydrogen tank

The at least one strap band clamper may be engaged to the tank mounting frame by a fastening member including a bolt and a nut.

A stack mounting frame may include a lower support member and an upper support member in the shape of an ‘8’ connected by welding along the vertical direction to form a closed space.

A tank mounting frame and a stack mounting frame may be connected by welding.

A tank mounting frame may be engaged to the front side member and the side sill by a fastening member including a bolt and a nut.

A stack mounting frame may be engaged to the side sill by a fastening member including a bolt and a nut.

A stack mounting frame may be engaged to the at least one fuel cell stack by a fastening member including a bolt and a nut.

A center floor assembly may include a center cross member positioned along the vehicle width direction.

A connected portion of a tank mounting frame and a stack mounting frame may engage the center cross member by a fastening member including a bolt and a nut.

An embodiment of the present disclosure can enable the construction of a hydrogen electric vehicle-based LCV without increasing the height of the vehicle body, by securing space to mount high-capacity fuel cell stacks and large-capacity hydrogen tanks.

Advantages that can be obtained or expected due to an embodiment are directly or implicitly disclosed in the detailed description of example embodiments. Various advantages predicted according to an embodiment will be disclosed in the detailed description that follows.

### BRIEF DESCRIPTION OF THE DRAWINGS

Example embodiments of this specification may be better understood by reference to the following description taken in conjunction with accompanying drawings in which similar reference symbols can designate identical or functionally similar elements.

FIG. 1 is a side view illustrating a vehicle body structure according to an embodiment of the present disclosure.

FIG. 2 is a bottom view illustrating a vehicle body structure according to an embodiment of the present disclosure.

FIGS. 3 and 4 are perspective views illustrating a vehicle body structure according to an embodiment of the present disclosure.

FIGS. 5 and 6 are partially exploded perspective views illustrating a vehicle body structure according to an embodiment of the present disclosure.

FIGS. 7 to 9 are drawings illustrating a mount tray assembly applied to a vehicle body structure according to an embodiment of the present disclosure.

FIGS. 10 and 11 are drawings illustrating a tank mounting frame of a mount tray assembly applied to a vehicle body structure according to an embodiment of the present disclosure.

FIG. 12 is a drawing showing a strip band clamper of a tank mounting frame applied to a vehicle body structure according to an embodiment of the present disclosure.

FIGS. 13 and 14 are drawings illustrating a stack mounting frame of a mount tray assembly applied to a vehicle body structure according to an embodiment of the present disclosure.

FIGS. 15A and 15B are drawings illustrating an assembled structure of a stack mounting frame and a fuel cell stack applied to a vehicle body structure according to an embodiment of the present disclosure.

FIGS. 16 to 20 are drawings showing the assembled state of a vehicle body structure according to an embodiment of the present disclosure.

It can be understood that the drawings referenced above are not necessarily drawn to scale, but rather present rather simplified representations of various features illustrating some basic principles through example embodiments of the present disclosure.

For example, certain design features of an embodiment of the present disclosure, including particular dimensions, direction, position, and shape, can be determined in part by a particular intended application and usage environment.

### DETAILED DESCRIPTION OF ILLUSTRATIVE EMBODIMENTS

The terminology used in this specification is for the purpose of describing particular example embodiments and is not intended to necessarily limit the present disclosure.

As used in this specification, a singular form can be intended to also include a plural form, unless the context clearly indicates otherwise.

It can be understood that the terms “comprises” and/or “comprising” as used herein indicate the presence of stated features, integers, steps, operations, elements, and/or components, but do not preclude the presence or addition of one or more other features, integers, steps, operations, components, and/or groups thereof.

As used in this specification, the term “and/or” includes any one or all combinations of one or more of the associated listed items

The term “connected” in this specification can indicate a physical relationship between two components in which the components are directly connected to each other by use of welding, rivets, self-piercing rivets (SPR), flow drill screws (FDS), structural adhesives, etc., or indirectly connected through one or more intermediate components.

The terms “vehicle,” “vehicular,” “automobile,” or other similar terms, used in this specification generally can include passenger automobiles, including sports cars, sports utility vehicles (SUVs), buses, trucks, various commercial vehicles, hybrid vehicles, electric vehicles, hybrid electric vehicles, hydrogen electric vehicles, electric-based purpose-built vehicles (PBVs), hydrogen electric-based LCVs (Light Commercial Vehicles), and other alternative fuel vehicles (e.g., fuel derived from resources other than petroleum), for example.

Hereinafter, example embodiments of the present disclosure are described in detail with reference to the accompanying drawing.

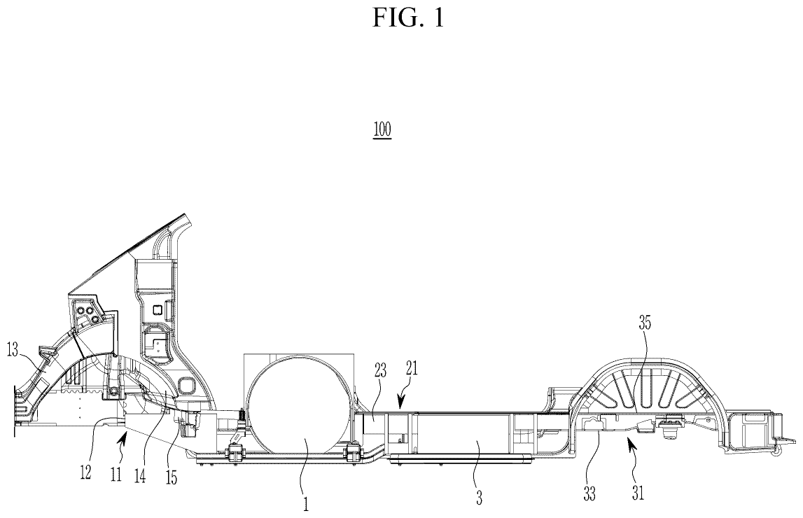

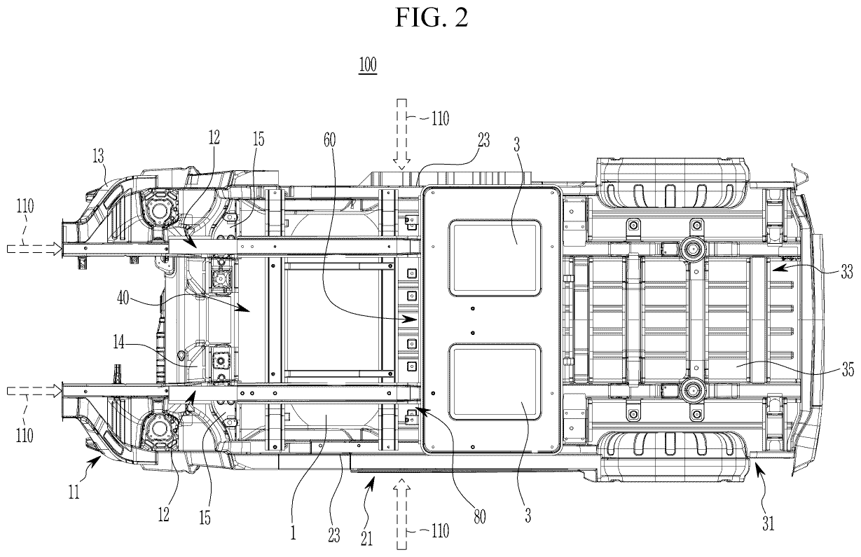

FIG. 1 is a side view illustrating a vehicle body structure according to an embodiment of the present disclosure. FIG. 2 is a bottom view illustrating a vehicle body structure according to an embodiment of the present disclosure.

Referring to FIGS. 1 and 2, a vehicle body structure 100 according to an embodiment may be applied to a vehicle body of a hydrogen electric vehicle.

The vehicle body structure 100 according to an embodiment may be applied to a vehicle body of a hydrogen electric vehicle-based LCV (Light Commercial Vehicle).

The LCV here could be manufactured as a 1.5 box design with a semi-bonnet rather than a 1 box design with a cab over, for example.

The vehicle body of the LCV may accommodate various components such as a high voltage battery (not shown), fuel cell stacks 1, hydrogen tanks 3, drive motor (not shown), inverter (not shown), and cooling module (not shown).

The vehicle body structure 100 according to an embodiment can be configured to mount the hydrogen tanks 1 and the fuel cell stacks 3 on the vehicle body of a hydrogen electric vehicle-based LCV.

In explaining the vehicle body structure 100 according to an embodiment, the vehicle body of an LCV can be assumed and explained, but it is not limited thereto and can be applied to hydrogen fuel-based vehicles of various specifications.

In this specification, the reference direction for explaining the components below may be set as the front-rear direction of the vehicle body (e.g., body length direction), the width direction (e.g., left-right direction), and the up-down direction (e.g., height direction) based on the vehicle body.

In this specification, the “upper part,” “upper portion,” “top” or “upper surface” of a component can indicate an end, section, or surface of the component that is relatively upper in the drawing, and the “lower part,” “lower portion,” or “lower surface” of a component can indicate an end, section, or surface of the component that is relatively lower in the drawing.

Additionally, in the specification, the term “end” of a component (e.g., one end, the other end, or both ends, etc.) can indicate an end of the component in any one direction, and the term “end portion” of a component (e.g., one end portion, the other end portion, both end portions, a front end portion, or a rear end portion, etc.) can indicate a portion of the component that includes that end.

The vehicle body structure 100 according to an embodiment can include a front body assembly 11, a center floor assembly 21, and a rear floor assembly 31 connected to each other along the front-rear direction of the vehicle body.

The front body assembly 11 can be positioned at the front of the vehicle body.

The front body assembly 11 can include front side members 12 arranged along the front-rear direction of the vehicle body on each side along the vehicle width direction.

The front body assembly 11 can include a fender apron member 13 and a dash panel 14 connected to the front side member 12.

The front body assembly 11 can include a front cross member 15 positioned along the vehicle width direction on the rear lower surface of the dash panel 14.

The center floor assembly 21 can be connected to the front body assembly 11 along the front-rear direction of the vehicle body.

The center floor assembly 21 can include side sills 23.

The side sills 23 can be arranged along the front-rear direction of the vehicle body on both sides of the center floor assembly 21 in the vehicle width direction, and can be connected to the front body assembly 11.

The rear floor assembly 31 can be connected to the center floor assembly 21 along the front-rear direction of the vehicle body.

The rear floor assembly 31 can include a rear under body 33 connected along the front-rear direction of the vehicle body with the side sill 23, and a rear floor panel 35 connected to the rear under body 33.

The vehicle body structure 100 according to an embodiment can provide a structure capable of securing a space for the mounting fuel cell stacks 3 and the hydrogen tanks 1.

Additionally, the vehicle body structure 100 according to an embodiment may provide a structure capable of securing mount strength and collision performance of the fuel cell stacks 3 and the hydrogen tanks 1.

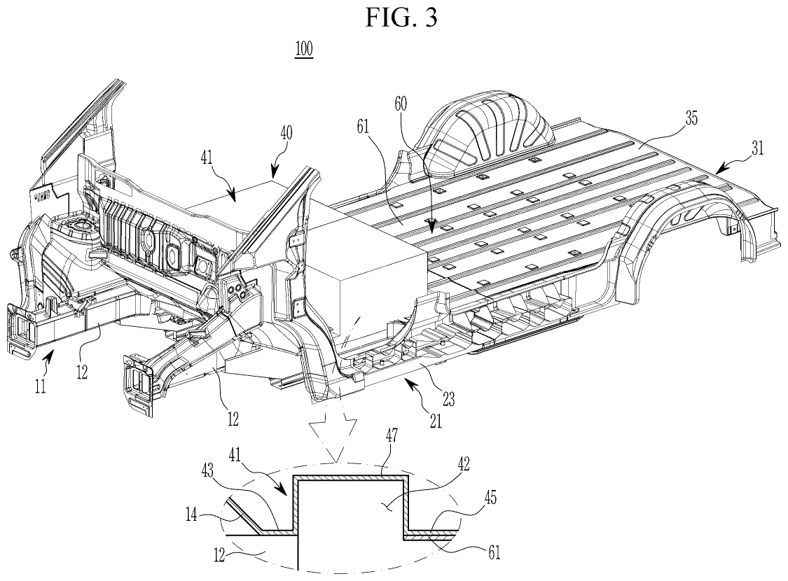

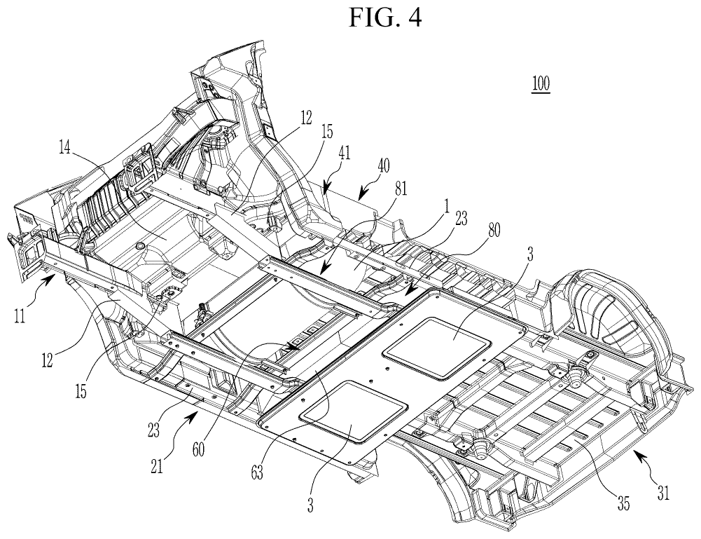

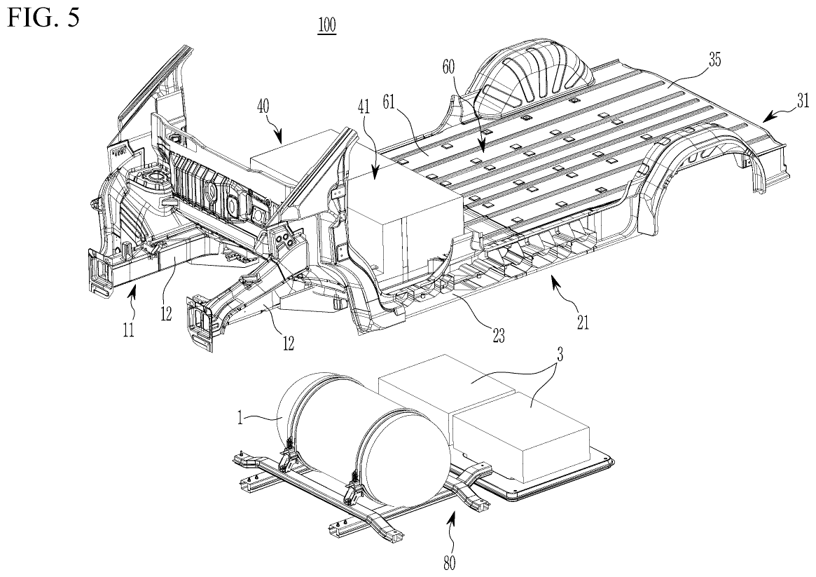

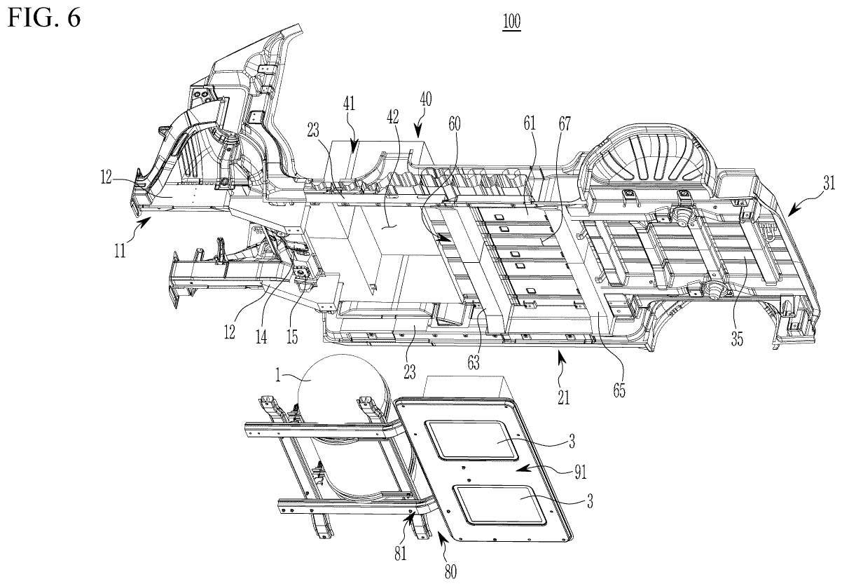

FIGS. 3 and 4 are perspective views illustrating a vehicle body structure 100 according to an embodiment of the present disclosure. FIGS. 5 and 6 are partially exploded perspective views illustrating a vehicle body structure 100 according to an embodiment of the present disclosure.

Referring to FIGS. 2 to 6, a vehicle body structure 100 according to an embodiment includes a hydrogen tank mounting unit 40, a fuel cell stack mounting unit 60, and a mount tray assembly 80.

In an embodiment, the hydrogen tank mounting unit 40 can be configured to mount at least one hydrogen tank 1 to the lower portion of the center floor assembly 21.

The hydrogen tank mounting unit 40 can be placed at the front of the center floor assembly 21 and connected to the front body assembly 11.

The hydrogen tank mounting unit 40 can include a seat mounting member 41.

In an embodiment, the fuel cell stack mounting unit 60 can be configured to mount at least one fuel cell stack 3, for example a pair of fuel cell stacks 3, to the lower portion of the center floor assembly 21.

The fuel cell stack mounting unit 60 can be placed at the rear of the center floor assembly 21 and can be connected to the hydrogen tank mounting unit 40 and the rear floor assembly 31.

The fuel cell stack mounting unit 60 can include a center floor panel 61, a center cross member 63, and a rear cross member 65 provided in the center floor assembly 21.

Hereinafter, the configuration of the hydrogen tank mounting unit 40 and the fuel cell stack mounting unit 60 according to an embodiment configured as described above will be specifically described.

The seat mounting member 41 of the hydrogen tank mounting unit 40 according to an embodiment can be connected to the front side member 12 of the front body assembly 11 along the front-rear direction of the vehicle body, and can be connected to the side sill 23 mentioned above along the vehicle width direction.

The seat mounting member 41 can be configured to mount a front seat (a person of an ordinary skill in the art is also commonly referred to as a “first row seat”) located at the front of the center floor assembly 21.

In one example, the seat mounting member 41 may be formed in a dome shape.

For example, the seat mounting member 41 may be formed in a square dome shape.

The front seat may be mounted on the upper part of the seat mounting member 41 using a seat mounting bracket, etc.

The seat mounting member 41 can be positioned between the front cross member 15 of the front body assembly 11 and the center cross member 63 of the fuel cell stack mounting unit 60.

The seat mounting member 41 can be formed in a dome shape, and a hydrogen tank mount space 42 may be formed at the bottom of the seat mounting member 41.

The seat mounting member 41 can include a front flange portion 43, a rear flange portion 45, and a seat mounting portion 47 (see, e.g., FIG. 3).

The front flange portion 43 can be formed at the front part of the seat mounting member 41 and may be connected to the front side member 12 of the front body assembly 11 and the dash panel 14 by welding.

The rear flange portion 45 can be formed at the rear of the seat mounting member 41 and may be connected to the center floor panel 61 mentioned above.

The seat mounting portion 47 can be positioned between the front flange portion 43 and the rear flange portion 45, and can be connected to the front flange portion 43 and the rear flange portion 45.

The seat mounting portion 47 can be formed in the dome shape of a quadrangle, in one example.

The hydrogen tank mount space 42, as mentioned above, can be formed at the lower part (or inside) of the seat mounting portion 47, and at least one hydrogen tank 1 may be placed (or mounted) in the hydrogen tank mount space 42.

The center floor panel 61 of the fuel cell stack mounting unit 60 according to an embodiment can be connected to the rear flange portion 45 of the seat mounting member 41 by welding.

The center floor panel 61 can be connected to the side sill 23 mentioned above.

The center floor panel 61 can be connected to the rear floor panel 35 of the rear floor assembly 31 by welding.

The front part of the center floor panel 61 can be connected to the seat mounting member 41, and the rear part of the center floor panel 61 can be connected to the rear floor panel 35.

The center cross member 63 and the rear cross member 65 of the fuel cell stack mounting unit 60 can be configured to reinforce the strength of the center floor panel 61.

The center cross member 63 and the rear cross member 65 can be arranged along the vehicle width direction and at predetermined intervals along the front-rear direction of the vehicle body.

The center cross member 63 and rear cross member 65 can be connected by welding to the side sill 23 and to the lower surface of the center floor panel 61.

A fuel cell stack mount space 67 can be formed between the lower surface of the center floor panel 61, the center cross member 63, and the rear cross member 65.

At least one fuel cell stack 3 may be placed (or mounted) in the fuel cell stack mount space 67.

Referring to FIGS. 2 to 6, in an embodiment, the mount tray assembly 80 can be configured to mount at least one hydrogen tank 1 and at least one fuel cell stack 3 on the hydrogen tank mounting unit 40 and the fuel cell stack mounting unit 60.

The mount tray assembly 80 can engage side sill 23.

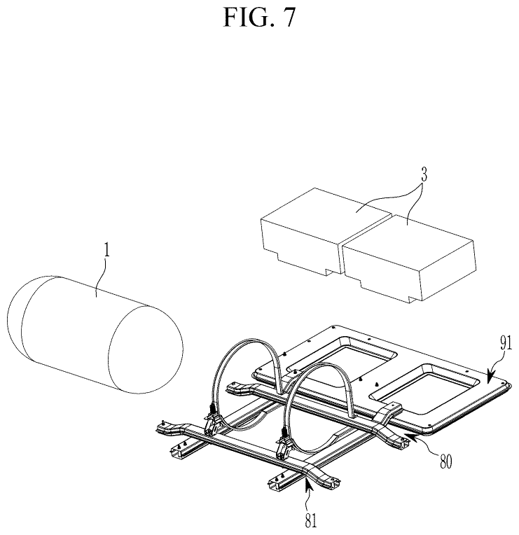

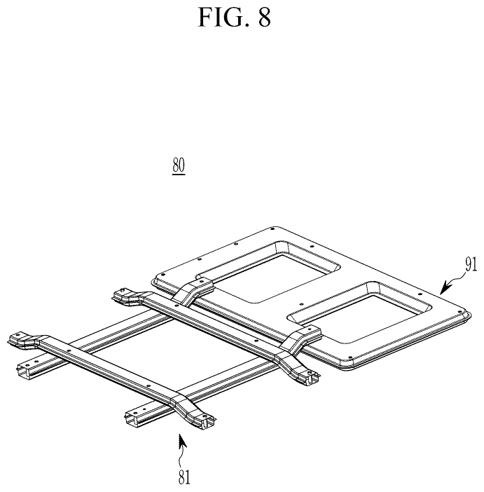

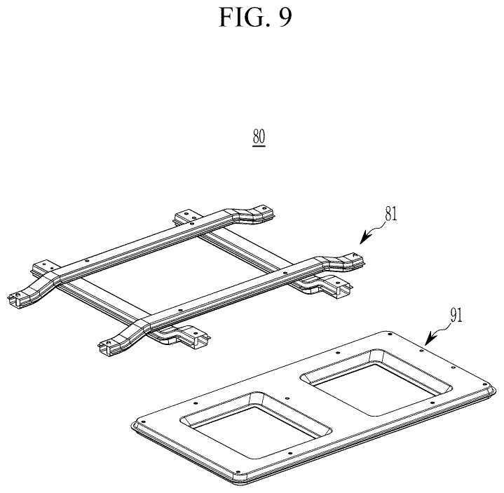

FIGS. 7 to 9 are drawings illustrating a mount tray assembly 80 that can be applied to a vehicle body structure according to an embodiment of the present disclosure.

Referring to FIGS. 3 to 9, the mount tray assembly 80 according to an embodiment can include a tank mounting frame 81 and a stack mounting frame 91.

The tank mounting frame 81 can be configured to mount at least one hydrogen tank 1 to the hydrogen tank mounting unit 40.

The tank mounting frame 81 can engage the front side member 12 and the side sill 23 at positions corresponding to the hydrogen tank mounting unit 40.

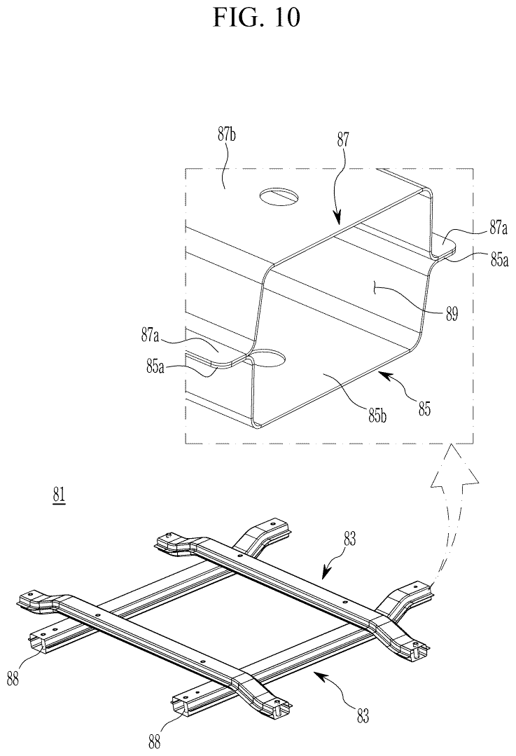

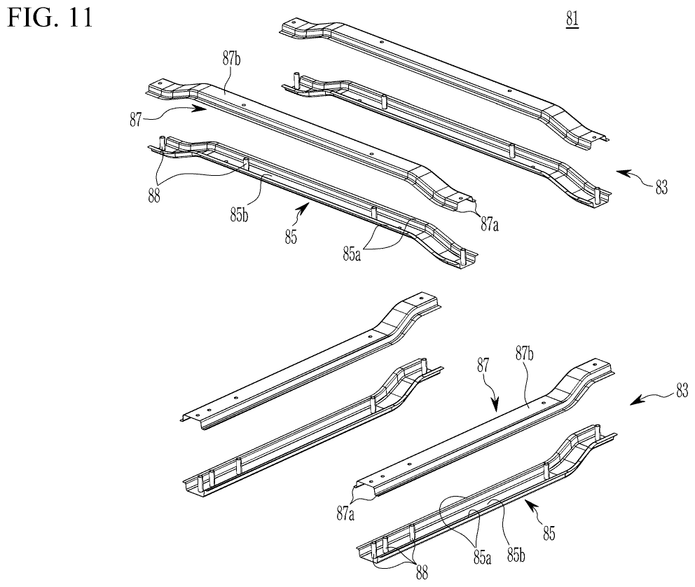

FIGS. 10 and 11 are drawings illustrating a tank mounting frame 81 of a mount tray assembly 80 that can be applied to a vehicle body structure according to an embodiment of the present disclosure.

Referring to FIGS. 10 and 11, the tank mounting frame 81 according to an embodiment can include a plurality of tank mount members 83.

The tank mount members 83 can be connected in a lattice shape along the front-rear direction of the vehicle body and the vehicle width direction.

The tank mount members 83, in one example, may be arranged in the form of a “#” shape.

One pair of the above tank mount members 83 can be arranged along the front-rear direction of the vehicle body, and the other pair can be arranged along the vehicle width direction.

The tank mount members 83, in one example, may be connected by welding.

Each of the tank mount members 83 can include a lower rail member 85 and an upper rail member 87 connected along the vertical direction.

The lower rail member 85 can include a lower rail flange portion 85a formed on each side along the length direction, and a lower rail forming portion 85b formed in a downward direction between the lower rail flange portions 85a.

The upper rail member 87 can include an upper rail flange portion 87a formed on both sides along the length direction, and an upper rail forming portion 87b formed in an upward direction between the upper rail flange portions 87a.

The lower rail member 85 and the upper rail member 87 may be connected by welding along the vertical direction through the lower rail flange portion 85a and the upper rail flange portion 87a.

Each of the tank mount members 83 can include a closed space 89 formed by the connection of the lower rail member 85 and the upper rail member 87.

The mount tray assembly 80 may include a plurality of pipe spacers 88 connected along the vertical direction inside the lower rail member 85 and the upper rail member 87.

The pipe spacers 88 can be connected to the lower rail forming portion 85b of the lower rail member 85 and the upper rail forming portion 87b of the upper rail member 87.

The pipe spacers 88 can penetrate the lower rail forming portion 85b and the upper rail forming portion 87b along the vertical direction, and may be connected to the lower rail forming portion 85b and the upper rail forming portion 87b by welding.

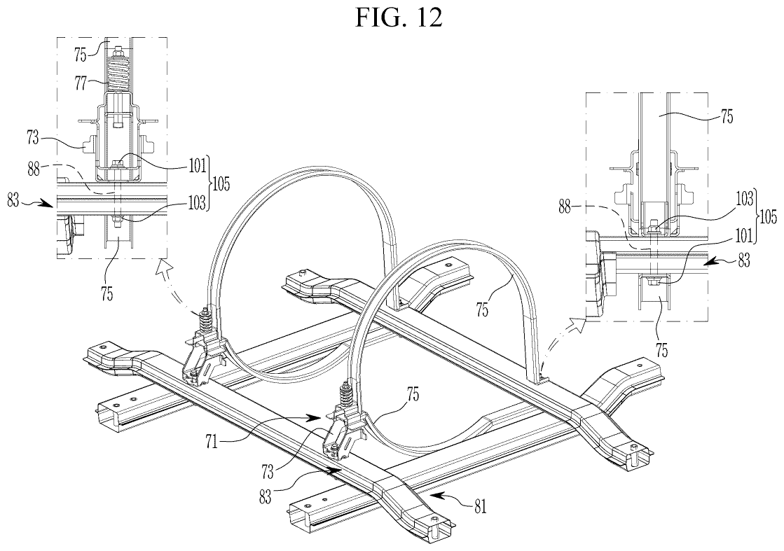

FIG. 12 is a drawing showing a strip band clamper 71 of a tank mounting frame 81 that can be applied to a vehicle body structure according to an embodiment of the present disclosure.

As shown in FIG. 12, at least one strip band clamper 71 can be mounted on the tank mounting frame 81 described above.

In one example, the at least one strip band clamper 71 may be mounted as a pair to the tank mounting frame 81.

The at least one strip band clamper 71 can be configured to clamp at least one hydrogen tank 1 to the tank mounting frame 81.

At least one strip band clamper 71 may include a mounting bracket 73 and a pair of strip bands 75.

The mounting bracket 73 can be connected to one of a pair of tank mount members 83 arranged along the vehicle width direction.

The mounting bracket 73 may be engaged to one tank mount member 83 by a fastening member 105 including a combination of a bolt 101 and a nut 103.

The bolt 101 can be connected vertically to the mounting bracket 73 and can be inserted vertically into one of the pipe spacers 88 provided inside one of the tank mount members 83.

The bolt 101 may be engaged with a nut 103 that can be welded to one tank mount member 83.

The strip bands 75 can be configured to surround the exterior circumference surface of at least one hydrogen tank 1 and secure at least one hydrogen tank 1 to the tank mount members 83.

One end of the strip bands 75 can be connected to the mounting bracket 73.

The other end of the strip bands 75 can be connected to another one of the tank mount members 83 arranged along the vehicle width direction.

One end of the strip bands 75 may be elastically connected to the mounting bracket 73 via a spring 77.

The other end of the strip bands 75 may be engaged to another tank mount member 83 by a fastening member 105 including a combination of a bolt 101 and a nut 103.

The bolt 101 can be connected to the other end of one of the strip bands 75 and can be fitted in a vertical direction into one of the pipe spacers 88 provided inside another tank mount member 83.

The bolt 101 can engage a nut 103 that can be welded to the other end of one of the strip bands 75.

These strip bands 75 can be provided in the shape of a belt of steel material.

The strip bands 75 may be provided in a circular band shape surrounding the exterior circumference surface of at least one hydrogen tank 1 by being connected to the mounting bracket 73 and another tank mount member 83.

Referring to FIGS. 6 to 9, in an embodiment, the stack mounting frame 91 can be configured to mount at least one fuel cell stack 3 to the fuel cell stack mounting unit 60.

The stack mounting frame 91 can be connected to the tank mounting frame 81 along the front-rear direction of the vehicle body and engage the side sill 23 at a position corresponding to the fuel cell stack mounting unit 60.

The stack mounting frame 91 can be connected to the tank mounting frame 81 by welding.

The stack mounting frame 91 can be connected by welding to a pair of tank mount members 83 arranged along the front-rear direction of the vehicle body of the tank mounting frame 81.

The stack mounting frame 91 may, in one example, be provided as an “8” shaped frame.

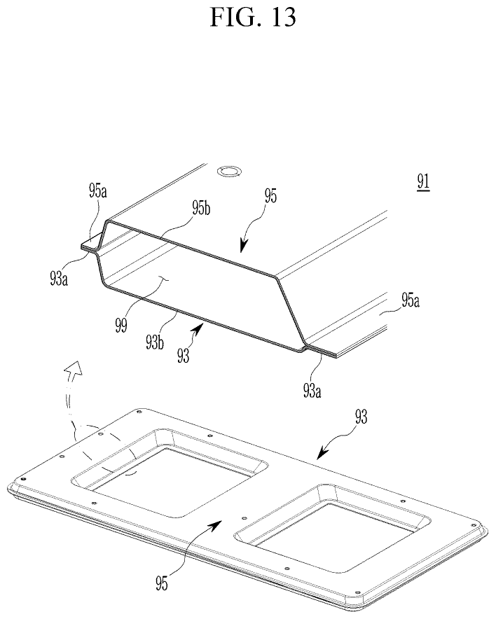

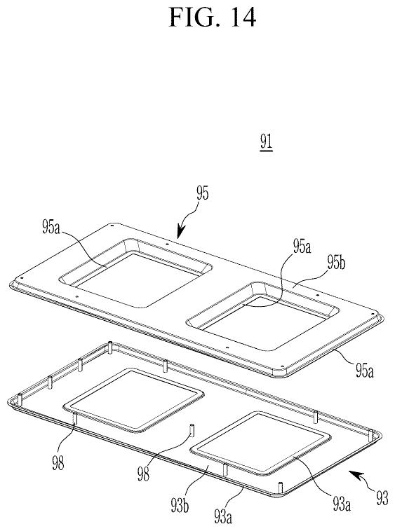

FIGS. 13 and 14 are drawings illustrating a stack mounting frame 91 of a mount tray assembly that can be applied to a vehicle body structure according to an embodiment of the present disclosure.

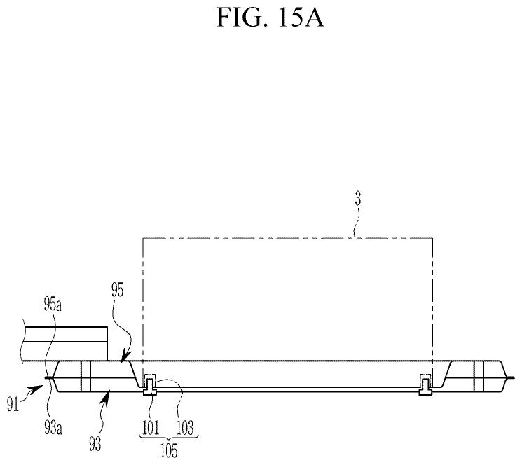

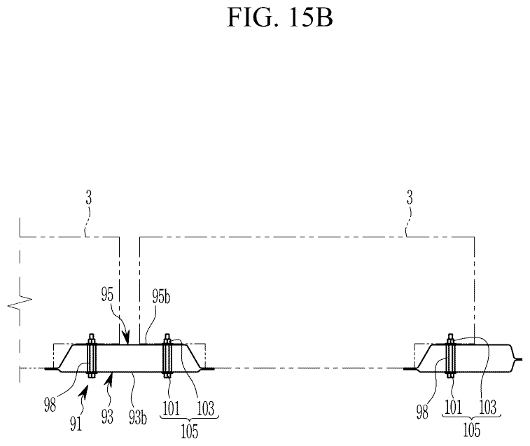

FIGS. 15A and 15B are drawings illustrating an assembled structure of a stack mounting frame and a fuel cell stack applied to a vehicle body structure according to an embodiment of the present disclosure.

Referring to FIGS. 13 to 15B, the stack mounting frame 91 according to an embodiment can include an ‘8’ shaped lower support member 93 and an upper support member 95 connected along the vertical direction.

The lower support member 93 can include a lower support flange portion 93a formed on each of the inner edge and the outer edge, and a lower support forming portion 93b formed in a downward direction between the lower support flange portions 93a.

The upper support member 95 can include an upper support flange portion 95a formed on each of the inner edge and the outer edge, and an upper support forming portion 95b formed in an upward direction between the upper support flange portions 95a.

The lower support member 93 and the upper support member 95 may be connected by welding along the vertical direction through the lower support flange portion 93a and the upper support flange portion 95a.

The stack mounting frame 91 can include a closed space 99 formed by connecting the lower support member 93 and the upper support member 95.

The stack mounting frame 91 may include a plurality of pipe spacers 98 connected along a vertical direction.

The pipe spacers 98 can be connected to the lower support forming portion 93b of the lower support member 93 and the upper support forming portion 95b of the upper support member 95.

The pipe spacers 98 can penetrate the lower support forming portion 93b and the upper support forming portion 95b along the vertical direction, and may be connected to the lower support forming portion 93b and the upper support forming portion 95b by welding.

At least one fuel cell stack 3 can be mounted on the stack mounting frame 91.

In one example, the at least one fuel cell stack 3 may be mounted as a pair on the stack mounting frame 91.

The at least one fuel cell stack 3 may be engaged to the stack mounting frame 91 by a fastening member 105 including a combination of a bolt 101 and a nut 103.

Specifically, the at least one fuel cell stack 3 may be engaged via the fastening member 105 to the welded lower support flange portion 93a and the upper support flange portion 95a of the lower support member 93 and the upper support member 95, as illustrated in FIG. 15A.

The lower support flange portion 93a and the upper support flange portion 95a formed on the inner edge of the stack mounting frame 91 may be engaged with at least one fuel cell stack 3 via the fastening member 105.

The bolt 101 of the fastening member 105 can be connected to the lower support flange portion 93a and the upper support flange portion 95a, which can be welded together, and can engage the nut 103 that can be welded to a bolt joint (not shown) of at least one fuel cell stack 3.

The at least one fuel cell stack 3 may be engaged via the fastening member 105 to the lower support forming portion 93b of the lower support member 93 and the upper support forming portion 95b of the upper support member 95, as illustrated in FIG. 15B.

The bolt 101 of the fastening member 105 can be fitted in a vertical direction into the pipe spacers 98 connected to the lower support forming portion 93b and the upper support forming portion 95b.

The bolt 101 can engage the nut 103 that can be welded to the bolt joint (not shown) of at least one fuel cell stack 3.

Hereinafter, the vehicle body mounting structure of the mount tray assembly 80, on which at least one hydrogen tank 1 and at least one fuel cell stack 3 can be mounted, will be described in detail with reference to the accompanying drawing.

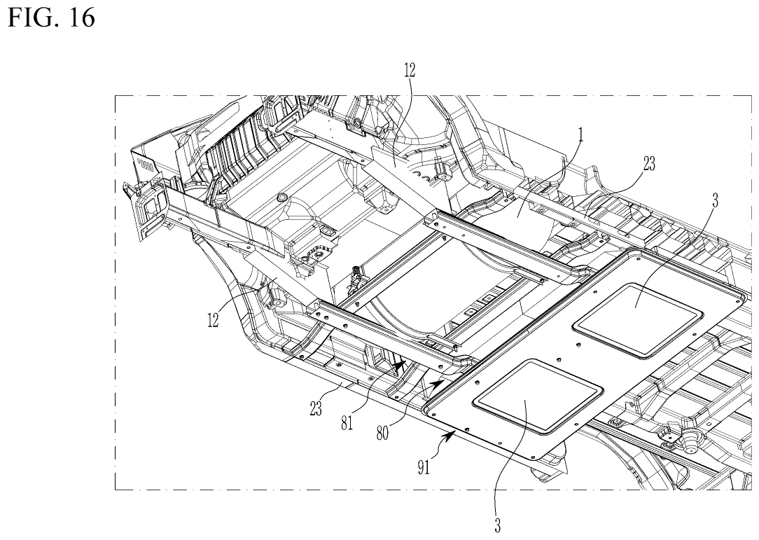

FIGS. 16 to 20 are drawings showing the assembled state of a vehicle body structure according to an embodiment of the present disclosure.

Referring to FIGS. 16 to 18, the tank mounting frame 81 of the mount tray assembly 80 can be engaged to the front side member 12 and the side sill 23 by the fastening member 105 including the bolt 101 and the nut 103.

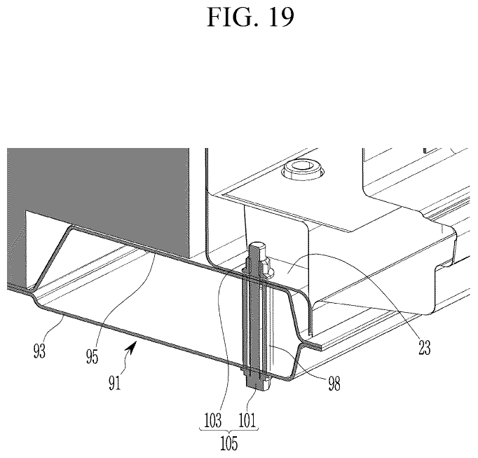

Referring to FIGS. 16 and 19, the stack mounting frame 91 of the mount tray assembly 80 can be engaged to the side sill 23 by the fastening member 105 including the bolt 101 and the nut 103.

At least one hydrogen tank 1 can be mounted on the tank mounting frame 81 and can be placed in the hydrogen tank mounting unit 40, and at least one fuel cell stack 3 can be mounted on the stack mounting frame 91 and can be placed in the fuel cell stack mounting unit 60 (see, e.g., FIG. 6).

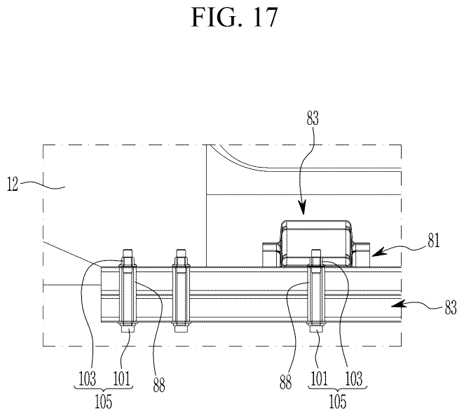

Specifically describing the vehicle body assemble structure of the mount tray assembly 80 as described above, as shown in FIG. 17, a pair of tank mount members 83 arranged along the front-rear direction of the vehicle body of the tank mounting frame 81 may be engaged to the front side member 12 through the fastening member 105.

The bolt 101 of the fastening member 105 can be fitted in a vertical direction into one of the pipe spacers 88 provided on the interior of the tank mount members 83 and engage the nut 103 welded to the front side member 12.

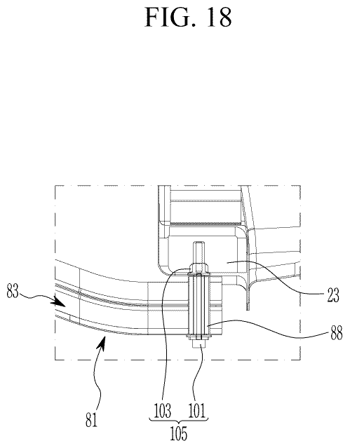

As shown in FIG. 18, another pair of tank mount members 83 can be arranged along the vehicle width direction of the tank mounting frame 81 may be engaged to the side sill 23 via the fastening members 105.

The bolt 101 of the fastening member 105 can be fitted in a vertical direction into one of the pipe spacers 88 provided inside the tank mount members 83 and engage the nut 103 welded to the side sill 23.

As shown in FIG. 17, a pair of tank mount members 83 can be arranged along the front-rear direction of the vehicle body and another pair of tank mount members 83 can be arranged along the vehicle width direction and may be engaged with each other by the pipe spacers 88 and the fastening member 105 including the bolt 101 and the nut 103.

On the other hand, the connected lower support member 93 and upper support member 95 of the stack mounting frame 91 may be engaged to the side sill 23 by the fastening member 105, as shown in FIG. 19.

The bolt 101 of the fastening member 105 can be fitted in a vertical direction into the pipe spacers 98 connected between the lower support member 93 and the upper support member 95, and engage the nut 103 welded to the side sill 23.

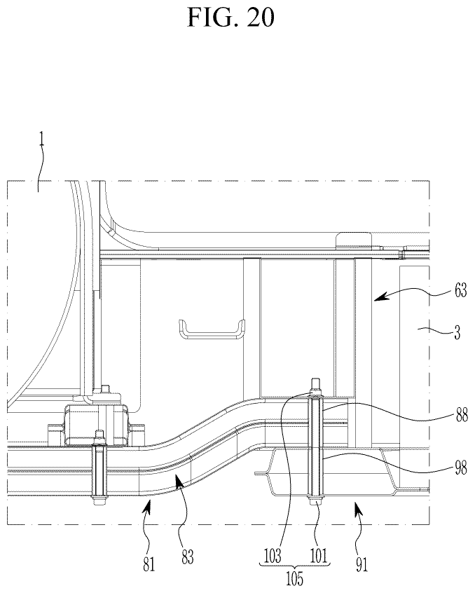

As shown in FIG. 20, the connected portion of the tank mounting frame 81 and the stack mounting frame 91 as described above may be engaged with the center cross member 63 mentioned above by the fastening member 105 including a combination of a bolt 101 and a nut 103.

The connected portion may be defined as a welding connected portion of a pair of tank mount members 83 arranged along the front-rear direction of the vehicle body of the tank mounting frame 81 and the stack mounting frame 91.

The bolt 101 of the fastening member 105 can be fitted along the vertical direction into one of the pipe spacers 88 connected to the interior of each of the tank mount members 83 and into one of the pipe spacers 98 connected to the interior of the stack mounting frame 91.

The bolt 101 can engage the nut 103 welded to the center cross member 63.

For a vehicle body structure 100 according to an embodiment assembled as described above, at least one hydrogen tank 1 may be mounted on the lower part of the seat mounting member 41, and at least one fuel cell stack 3 may be mounted on the lower part of the center floor panel 61.

A vehicle body structure 100 according to an embodiment can secure a space capable of mounting the large-capacity hydrogen tank 1 and the high-capacity fuel cell stack 3, thereby enabling the hydrogen electric vehicle-based LCV to be configured without increasing the height of the vehicle body.

A vehicle body structure 100 according to an embodiment can secure A/S performance of at least one hydrogen tank 1 and at least one fuel cell stack 3 by applying A/S holes to the seat mounting member 41 and the center floor panel 61.

For a vehicle body structure 100 according to an embodiment, the mount tray assembly 80 having at least one hydrogen tank 1 and at least one fuel cell stack 3 mounted thereon can be engaged with the front side member 12, the side sill 23, and the center cross member 63.

Therefore, a vehicle body structure 100 according to an embodiment can secure mount strength along the front-rear direction of the vehicle body, vehicle width direction, and vertical direction of at least one hydrogen tank 1 and at least one fuel cell stack 3.

A vehicle body structure 100 according to an embodiment can form a load paths 110 (see FIG. 2) along the front-rear direction of the vehicle body and vehicle width direction by the mount tray assembly 80, thereby dispersing collision load during frontal collision and side collision of the vehicle.

Due to this, a vehicle body structure 100 according to an embodiment can minimize damage to at least one hydrogen tank 1 and at least one fuel cell stack 3 in the event of a vehicle collision.

While the present disclosure has been described in connection with what is presently considered to be practical example embodiments, it can be understood that the present disclosure is not necessarily limited to the disclosed example embodiments. The present disclosure is intended to cover various modifications and equivalent arrangements included within the spirit and scopes of the appended claims.

What is claimed is:

1. A vehicle body structure comprising:
a front body assembly, a center floor assembly, and a rear floor assembly connected to each other along a front-rear direction of a vehicle body;
a side sill arranged along the front-rear direction of the vehicle body on both sides of a vehicle width direction of the center floor assembly and connected to the front body assembly;
a hydrogen tank mounting structure positioned at a front portion of the center floor assembly and configured to mount at least one hydrogen tank to a lower portion of the center floor assembly; and
a fuel cell stack mounting structure positioned at a rear portion of the center floor assembly and configured to mount at least one fuel cell stack to the lower portion of the center floor assembly.

2. The vehicle body structure of claim 1, further comprising a mount tray assembly engaged with the side sill and configured to mount the at least one hydrogen tank and the at least one fuel cell stack to the hydrogen tank mounting structure and the fuel cell stack mounting structure, respectively.

3. The vehicle body structure of claim 1, wherein the hydrogen tank mounting structure comprises a seat mounting member connected to a front side member of the front body assembly and connected to the side sill.

4. The vehicle body structure of claim 3, wherein the fuel cell stack mounting structure comprises:
a center floor panel connected to a rear of the seat mounting member; and
a center cross member and a rear cross member connected along the vehicle width direction to the side sill and connected at a predetermined interval to a lower surface of the center floor panel.

5. The vehicle body structure of claim 4, wherein the seat mounting member is positioned between a front cross member and the center cross member, which are positioned along the vehicle width direction in the front body assembly.

6. The vehicle body structure of claim 4, wherein the seat mounting member comprises:
a front flange portion connected to a dash panel and the front side member of the front body assembly;
a rear flange portion connected to the front portion of the center floor panel; and
a seat mounting portion extending between the front flange portion and the rear flange portion.

7. The vehicle body structure of claim 3, wherein a hydrogen tank mount space is defined at a bottom of the seat mounting member.

8. The vehicle body structure of claim 4, wherein a fuel cell stack mount space is defined between the lower surface of the center floor panel, the center cross member, and the rear cross member.

9. The vehicle body structure of claim 2, wherein the mount tray assembly comprises:
a tank mounting frame engaging the side sill at a first position corresponding to the hydrogen tank mounting structure configured to mount the at least one hydrogen tank; and
a stack mounting frame connected to the tank mounting frame, wherein the stack mounting frame is configured to mount the at least one fuel cell stack and wherein the stack mounting frame is engaged with the side sill at a second position corresponding to the fuel cell stack mounting structure.

10. The vehicle body structure of claim 9, wherein the tank mounting frame comprises a plurality of tank mount members connected in a lattice form.

11. The vehicle body structure of claim 10, wherein each of the tank mount members comprises a lower rail member and an upper rail member connected by welding along a vertical direction to form a closed space therebetween the lower rail member and the upper rail member.

12. The vehicle body structure of claim 10, wherein the tank mount members are arranged in a generally “#” shape and connected by welding.

13. The vehicle body structure of claim 9, wherein the tank mounting frame is equipped with at least one strap band clamper that is configured to clamp the at least one hydrogen tank; and
wherein the at least one strap band clamper is engaged to the tank mounting frame by a fastening member including a bolt and a nut.

14. The vehicle body structure of claim 9, wherein the stack mounting frame comprises a lower support member and an upper support member in a generally “8” shape and connected by welding along a vertical direction to form a closed space therebetween the lower support member and the upper support member.

15. The vehicle body structure of claim 9, wherein the tank mounting frame and the stack mounting frame are connected by welding;
wherein the tank mounting frame is engaged to a front side member and the side sill by a first fastening member including a first bolt and a first nut; and
wherein the stack mounting frame is engaged to the side sill by a second fastening member including a second bolt and a second nut, and is engaged to the at least one fuel cell stack by a third fastening member including a third bolt and a third nut.

16. The vehicle body structure of claim 9, wherein the center floor assembly includes a center cross member positioned along the vehicle width direction; and
wherein a connected portion of the tank mounting frame and the stack mounting frame engages the center cross member by a fastening member including a bolt and a nut.

17. A vehicle comprising:
a front body assembly, a center floor assembly, and a rear floor assembly connected to each other along a front-rear direction of a vehicle body;
a side sill arranged along the front-rear direction of the vehicle body on both sides of a vehicle width direction of the center floor assembly and connected to the front body assembly;
a hydrogen tank mounting structure positioned at a front portion of the center floor assembly and configured to mount at least one hydrogen tank to a lower portion of the center floor assembly; and
a fuel cell stack mounting structure positioned at a rear portion of the center floor assembly and configured to mount at least one fuel cell stack to the lower portion of the center floor assembly.

18. The vehicle of claim 17, wherein the vehicle is a hydrogen electric vehicle-based commercial vehicle.

19. The vehicle of claim 18, wherein the vehicle is classified as light commercial vehicle (LCV) type.

20. The vehicle of claim 17, wherein the vehicle comprises:
a driver seating area located on the hydrogen tank mounting structure; and
a vehicle cargo area located on the fuel cell stack mounting structure.
